(19) United States
(12) Patent Application Publication
(10) Pub. No.: US 2023/0001399 A1
(43) Pub. Date: Jan. 5, 2023

(54) NEW TRANSITION METAL CATALYST

(71) Applicant: DSM IP Assets B.V., HEERLEN (NE)

(72) Inventors: Werner BONRATH, Kaiseraugst (CH); Frederic BOURGEOIS, BASEL (CH); Jonathan Alan MEDLOCK, Kaiseraugst (CH); Christof SPARR, BASEL (CH)

(21) Appl. No.: 17/774,650

(22) PCT Filed: Nov. 2, 2020
(86) PCT No.: PCT/EP2020/080685

§ 371 Date: May 5, 2022

(30) Foreign Application Priority Data
Nov. 7, 2019 (EP) 19207604.0

(51) Int. Cl. B01J 31/22; C07F 15/00

(52) U.S. Cl. CPC B01J 31/2243; C07F 15/00; B01J 2531/827; B01J 2231/643

(57) ABSTRACT

The present invention relates to specific transition metal catalysts and their use in chemical reactions.

The present invention relates to specific transition metal catalysts and their use in chemical reactions.

In the field of chemical reactions and chemical production processes, catalysts are used to speed up reactions and improve the reaction selectivity by accelerating specific transformations. This allows reactions to take place under milder reaction conditions, resulting in higher yields and selectivities and lower amounts of waste. Within the field of homogeneous catalysis, combinations of transition metal and organic ligands can be used for many transformations resulting in good selectivities.

Despite their applicability, homogeneous catalysts can be quickly deactivated, meaning that relatively high loadings of catalyst are required. Therefore there is always the need for novel catalysts that perform with higher selectivity and activity at lower loadings.

Therefore the present invention relates to new transition metal catalysts (C), which are organo-metallic catalysts of the following formula:

[M(III)QX(Y)ₙ] (I),

wherein M is a transition metal chosen from the list of Ru, Rh and Ir, preferably Ir Q is the ligand L or an anion of the ligand L, wherein
the ligand L has the following formula (II)

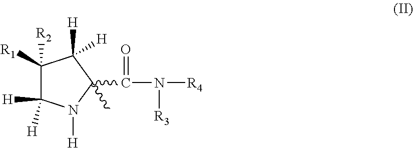

wherein
R₁ is H, CH₃ or OH,
R₂ is H, CH₃ or OH,
R₃ is H or CH₃
R₄ is a C₂-C₄ alkyl group, which is substituted by at least one OH group and which is optionally further substituted, with the provisos that
   when R₁ is OH or CH₃, then R₂ is H and
   when R2 is OH or CH3, then R₁ is H, and
X is cyclopentadienyl, or a substituted cyclopenadienyl group, preferably indenyl or pentamethylcyclopentadienyl, and
Y is an anion and n is 1 or 2, with the proviso that the value of n is chosen such that the overall metal complex is a neutral species.

The new catalyst according to the present invention can be used in a variety of chemical reactions.

As stated above, Q is either the neutral ligand L or an anion of the ligand L. The anion of the ligand L can be prepared by deprotonation of the ligand L before complexing with the transistion metal atom M to form complex C; or the anion of ligand L can be formed during the complexation to the transition metal atom M to form complex C.

Therefore, the present invention relates to new transition metal catalysts catalysts (C1), which are catalyst (C), wherein M is Ir.

The ligand of formula (II) has the following two enantiomeric forms. These are the following ligands of formula (IIa) and (IIb):

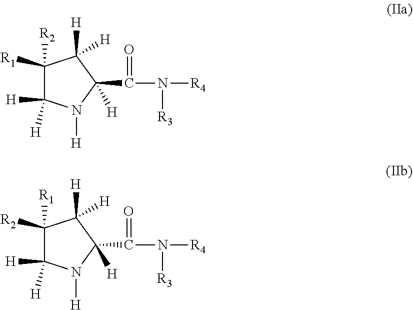

wherein the substituents have the same meanings as for the compound of formula (I).

Therefore, the present invention relates to new catalysts (C2), which are transition metal catalysts (C) or (C1), wherein L is a ligand of formula (IIa)

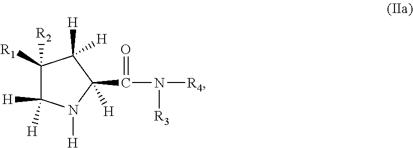

and wherein the substituents have the same meanings as for the compound of formula (I).

Therefore, the present invention relates to new catalysts (C2′), which are transition metal catalysts (C) or (C1), wherein L is a ligand of formula (IIb)

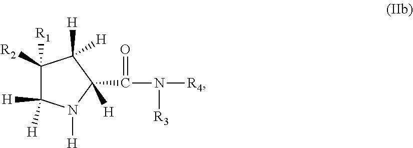

and wherein the substituents have the same meanings as for the compound of formula (I).

Therefore, the present invention relates to new catalysts (C2″), which are transition metal catalysts (C) or (C1), wherein Lisa mixture of ligands of formula (IIa)

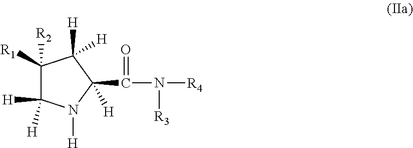

and of formula (IIb)

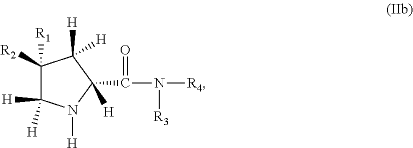

and wherein the substituents have the same meanings as for the compound of formula (I).

More preferred are catalyst of formula (I), wherein the ligand L is one of the following formula (II′a)-(II′″″a) or (IIb)-(II′″″b):

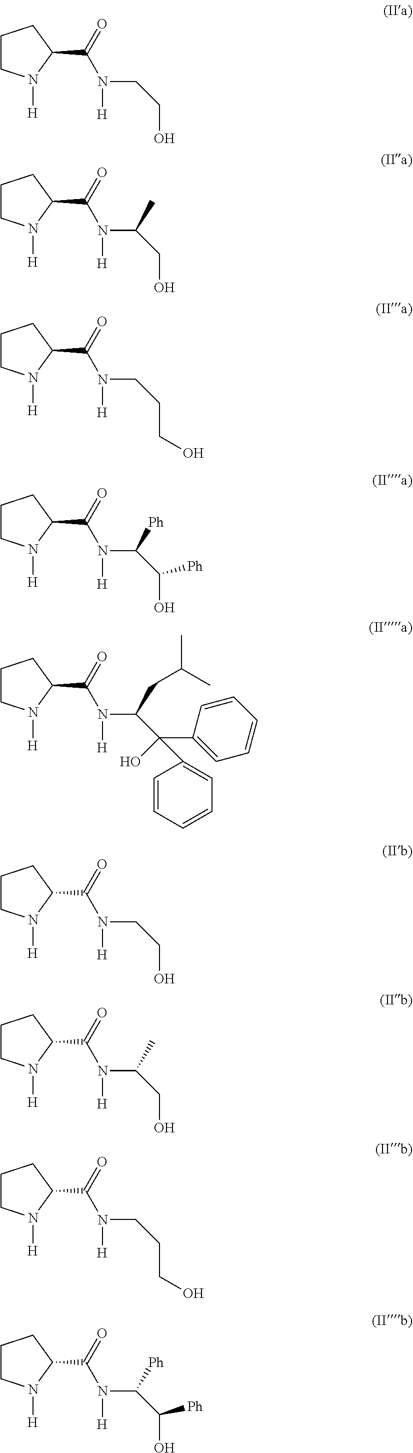

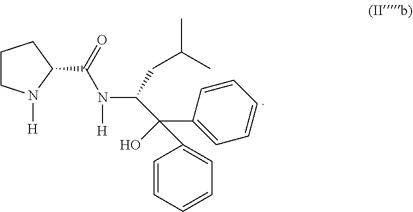 [SMILES: CC(C)C[C@@H](NC(=O)[C@H]1CCCN1)C(O)(c1ccccc1)c1ccccc1]

Therefore, the present invention relates to new catalysts (C2′″), which are transition metal catalysts (C) or (C1), wherein L is a ligand of formula (II′a)-(II′″″a) or (IIb)-(II′″″b):

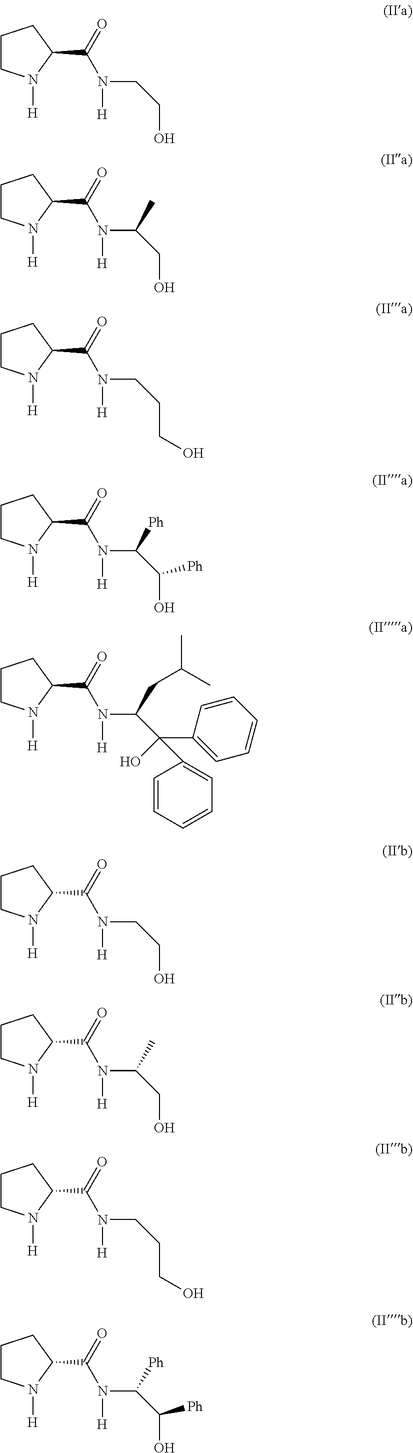

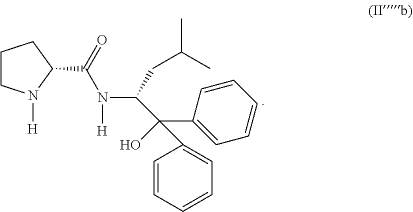 [SMILES: CC(C)C[C@@H](NC(=O)[C@H]1CCCN1)C(O)(c1ccccc1)c1ccccc1]

Most preferred are the ligands of formula (II′a) and (II′b)

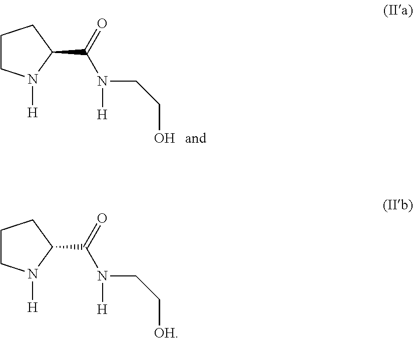 [SMILES: O=C(NCCO)[C@@H]1CCCN1 ; O=C(NCCO)[C@H]1CCCN1]

Therefore, the present invention relates to new catalysts (C2′″″), which are transition metal catalysts (C) or (C1), wherein L is a ligand of formula (II′a)

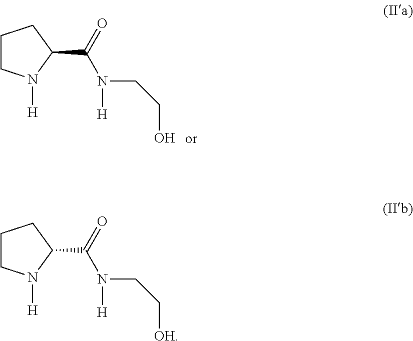 [SMILES: O=C(NCCO)[C@@H]1CCCN1 ; O=C(NCCO)[C@H]1CCCN1]

The counteranion Y in the compound of formula (I) may be any commonly used anion. Suitable ones include halides, carboxylates, formate (HCOO⁻), hydride (H⁻), borohydride (BH₄⁻), borates (BR₄⁻), and fluorinated anions (such as, but not restricted to: BF₄⁻, PF₆⁻SbF₆⁻, BAr^{F}₄⁻(which is tetrakis[3,5-bis(trifluoromethyl)phenyl]borate)), Preferred anions Y are hydride or a halide, especially preferred is Cl⁻.

Therefore, the present invention relates to new catalysts (C3), which are transition metal catalysts (C1), (C2), (C2′), (C2″), (C2′″) or (C2″″), wherein Y is chosen from the group consisting of a halide, carboxylate, formate, hydride, borohydride, borate, BF₄⁻, PF₆⁻SbF₆⁻and BAr^{F}₄⁻.

Therefore, the present invention relates to new catalysts (C3′), which are transition metal catalysts (C1), (C2), (C2′), (C2″), (C2′″) or (C2″″), wherein Y is chosen from the group consisting of hydride and halide.

Therefore, the present invention relates to new catalysts (C′3′), which are transition metal catalysts (C1), (C2), (C2′), (C2″), (C2′″) or (C2″″), wherein Y is Cl⁻. The catalyst according to the present invention ([M(III)QX(Y)n]) can be produced by combining the relevant components together such as by reacting Q with a metal precursor in a suitable solvent. Q can be the neutral ligand L or an anion of the ligand L. If Q is an anion of ligand L, the anion can be formed before the metal precursor is added, or at the time of complexation to the metal precursor. The anion is usually formed by the addition of base.

The catalyst solution can be used as produced, or the catalyst can be isolated and used at a later time. The catalyst according to the present invention can be used in a variety of chemical processes such as for example reduction reactions and isomerisations, in particular transfer hydrogenations and racemisations. Very preferred reactions, which are catalyzed by the catalyst according to the present invention are transfer hydrogenations.

It is possible to add the catalyst as such to the reaction mixture (the order of addition of all the reactants that are added can vary). It is also possible that the catalyst is formed in situ in the reaction mixture. This means that the catalyst is not added as such but it is formed in the reaction mixture.

The following examples serve to illustrate the invention. If not otherwise stated, the temperature is given in ° C.

### EXAMPLES

The ligands used are either commercially available or can be prepared using known methods. One method to prepare a range of ligands is described below.

### General Procedure for Preparation of Ligands

An oven-dried flask was charged with Cbz-D-proline or Cbz-L-proline (1.00 eq.) or a proline derivative and dry dichloromethane (0.20 mol/L). The solution was cooled to 0° C. and triethylamine (1.00 eq.) and isobutyl chloroformate (1.00 eq.) were added. The mixture was stirred for 0.5 h, and the relevant amine (1.00 eq.) was added. The mixture was warmed to room temperature and stirred until complete conversion (monitored by TLC). The mixture was washed with aq. sat. NH₄Cl, aq. sat. NaHCO₃ and brine. Each aqueous layer was re-extracted with dichloromethane. The combined organic layers were dried over Na₂SO_{4,} filtered and concentrated in vacuo. The crude intermediate could be purified or used in the following step without further purification. The intermediate (1.00 eq.) was dissolved in MeOH (0.40 mol/L), the flask was flushed with argon three times and Pd/C (10.0 wt. %, 5.00 mol %) was added in one portion. The mixture was evacuated and flushed with hydrogen five times. The black suspension was stirred at room temperature under a hydrogen atmosphere until complete conversion (monitored by TLC). The reaction mixture was filtered over a plug of celite and rinsed with methanol.

### Example 1 - (R)-N-(2-Hydroxyethyl)Pyrrolidine-2-Carboxamide (Ligand II′b)

According to the procedure above: Cbz-D-proline (2.49 g,10.0 mmol, 1.00 eq.), triethylamine (1.41 mL, 10.0 mmol, 1.00 eq.), isobutyl chloroformate (1.30 mL, 10.0 mmol, 1.00 eq.) and ethanolamine (1.21 mL, 10.0 mmol, 1.00 eq.) were reacted to form the intermediate (2.08 g).

The intermediate (2.03 g, 6.94 mmol, 1.00 eq.) and Pd/C (10.0 wt. %, 368 mg, 347 μmol, 5.00 mol %) yielded ligand (II′b) as a colorless liquid (1.10 g, quant.).

### Example 2: Preparation of Ethyl (R)-2-Hydroxy-3,3-Dimethyl-4-Oxobutanoate

To a solution of (R)-N-(2-hydroxyethyl)pyrrolidine-2-carboxamide (II′b, 79.1 mg, 500 μmol, 5.00 mol%) in t-BuOH (10.0 mL), isobutanal (910 pL,10.0 mmol, 1.00 eq.) and ethyl glyoxalate (50.0% in toluene, 1.98 mL,10.0 mmol, 1.00 eq.) were added. The mixture was stirred at room temperature for 24 h. The solvent was removed in vacuo and the residue purified by column chromatography (cyclohexane/ethyl acetate, 4:1) yielding ethyl (R)-2-hydroxy-3,3-dimethyl-4-oxobutanoate (VI) (1.47 g, 84%, 72% ee) as a colorless oil. 1H NMR (400 MHz, CDCl3) δ=9.57 (1H, s), 4.32 (1H, s), 4.30-4.18 (2H, m), 3.06 (1H, br), 1.27 (3H, t), 1.14 (3H,s), 1.05 (3H, s). The analytical data was in agreement with an authentic sample.

### Example 3: Preparation of Catalyst [IrCl(Cp*)(Anion of Ligand II′b)]

To a solution of (IrCl₂(Cp*))₂ (19.9 mg, 25.0 μmol, 1.00 eq.) in dry toluene was added (R)-N-(2-hydroxyethyl)pyrrolidine-2-carboxamide (II′b, 7.91 mg, 50.0 μmol, 2.00 eq.) and triethylamine (11.0 μL, 75.0 μmol, 3.00 eq.). The solution was stirred at room temperature for 4 h. The solvent was decanted with a syringe to obtain a yellow precipitate. The catalyst could be recrystallised from hexane/chloroform. 1H NMR (500 MHz, CDCl3)β=5.63 (1H, br), 4.33 (1H, br), 3.98 (1H, m), 3.79 (2H, m), 3.64 (1H, m), 3.58 (1H, br), 3.44 (1H, m), 3.13 (1H, m), 2.14 (1H, m), 2.02 (1H, m), 1.85 (1H, m), 1.78 (1H, m), 1.67 (15H, s); 13C NMR (126 MHz, CDCl3) β=181.5, 85.5, 65.1, 64.0, 54.3, 52.4, 29.8, 26.7, 9.5.

### General Procedure for Transfer Hydrogenation Ethyl (R)-2-Hydroxy-3,3-Dimethyl-4-Oxobutanoate to Yield (R)-2-Hydroxy-3,3-Dimethyl-γ-Butyrolactone

The preformed transition metal catalyst or the transition metal salt and the ligand were added to a solution of ethyl (R)-2-hydroxy-3,3-dimethyl-4-oxobutanoate (from example 2) in water:tert-butanol (2:1). The mixture was degassed, sodium formate (5 eq.) was added and the mixture was stirred at the desired temperature for the stated time. The reaction mixture extracted with MTBE or dichloromethane and the combined organic phases were dried, filtered and concentrated in vacuo.

| | | | T | T | Conv. |
|---|---|---|---|---|---|
| Example | Ligand | Metal precursor and loading | [° C.] | [h] | [%] |
| 3a | II′b | (RuCl₂(p-cymene))₂ 0.50 mol % | rt | 26 | 98 |
| 3b | II′b | (IrCl₂Cp*)₂0.50 mol % | 40 | 1 | 99 |
| 3c | II′b | (IrCl₂Cp*)₂ 0.50 mol % | rt | 4 | 99 |
| 3d | II′b | (IrCl₂Cp*)₂ 0.25 mol % | 40 | 2 | 93 |
| 3e | II′b | (IrCl₂Cp*)₂ 0.10 mol % | 40 | 5 | 99 |
| 3f | II′b | (RhCl₂Cp*)₂ 0.50 mol % | 40 | 2.5 | 97 |

Examples 3b to 3f are the examples claimed by the present patent claims, whereas 3a is a comparison example.

1. A transition metal catalyst of the formula (I)
[M(III)QX(Y)ₙ] (I),
wherein M is a transition metal chosen from the list of Ru, Rh and Ir, preferably Ir, and Q is the ligand L or an anion of the ligand L, wherein
the ligand L has the following formula (II) 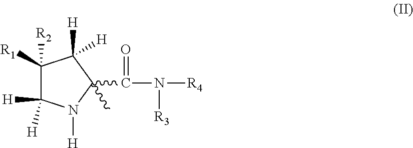
wherein
R₁ is H, CH₃ or OH,
R₂ is H, CH₃ or OH,
R₃ is H or CH₃
R₄ is a C₂-C₄ alkyl group, which is substituted by at least one OH group and which is optionally further substituted,
with the provisos that
when R₁ is OH or CH_{3,} then R₂ is H and
when R₂ is OH or CH_{3,} then R₁ is H, and
X is cyclopentadienyl, or a substituted cyclopenadienyl group, preferably indenyl or pentamethylcyclopentadienyl, and
Y is an anion and n is 1 or 2, with the proviso that the value of n is chosen such that the overall metal complex is a neutral species.

2. Transition metal catalyst according to claim 1, wherein M is Ir.

3. Transition metal catalyst according to claim 1, wherein L is a ligand of formula (IIa)

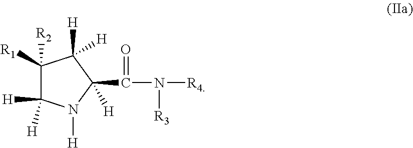

4. Transition metal catalyst according to claim 1, wherein L is a ligand of formula (IIb)

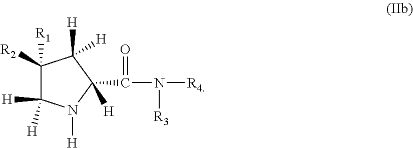

5. Transition metal catalyst according to claim 1, wherein L is a mixture of ligands of formula (IIa) 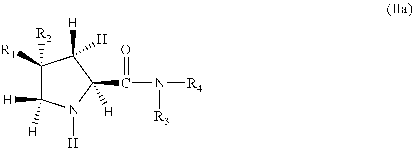
and of formula (IIb)

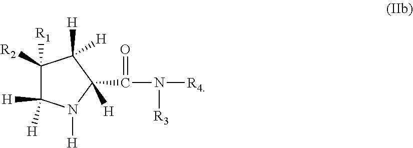

6. Transition metal catalyst according to claim 1, wherein L is a ligand of formula (II′a)-(II′″″a) or (II′b)-(II′″″b):

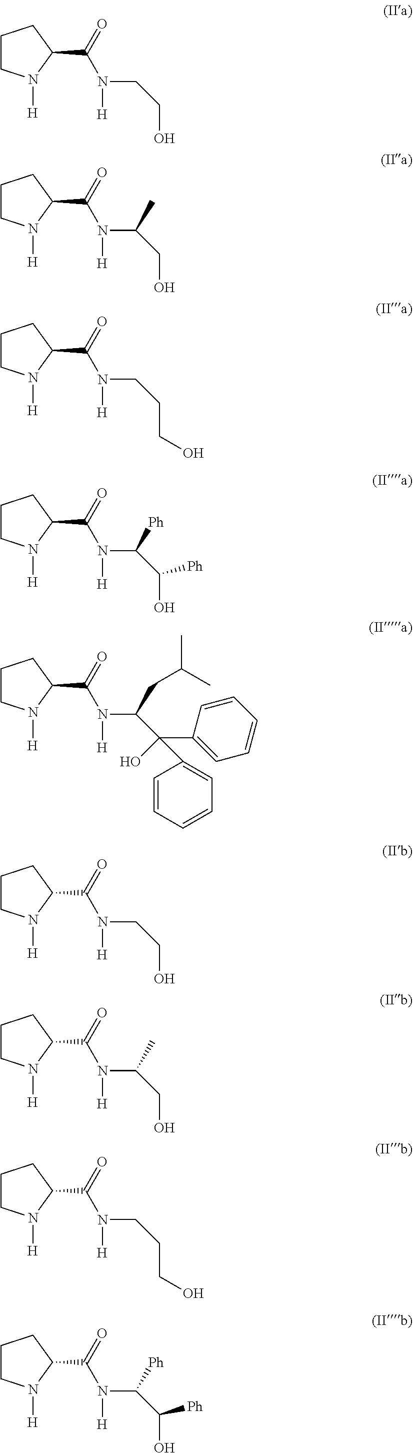

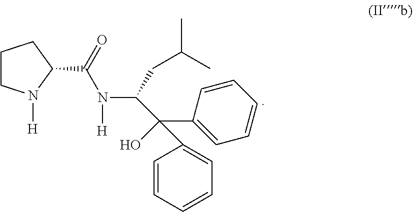 [SMILES: CC(C)C[C@@H](NC(=O)[C@H]1CCCN1)C(O)(c1ccccc1)c1ccccc1]

7. Transition metal catalyst according to claim 1, wherein L is a ligand of formula (II′a)

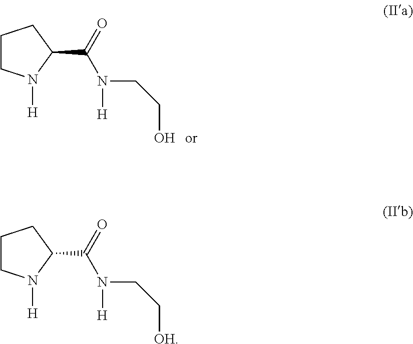 [SMILES: O=C(NCCO)[C@@H]1CCCN1 ; O=C(NCCO)[C@H]1CCCN1]

8. Transition metal catalyst according to claim 1, wherein Y is chosen from the group consisting of a halide, carboxylate, formate, hydride, borohydride, borate, BF₄⁻, PF₆⁻SbF₆⁻and BAr^{F}₄⁻.

9. Transition metal catalyst according to claim 1, wherein Y is chosen from the group consisting of hydride and halide.

10. Transition metal catalyst according to claim 1, wherein Y is Cl⁻.

11. Use of at least one transition metal catalyst according to claim 1 in a chemical process.

12. Use according to claim 11, which is reduction reaction.
